(19) United States
(12) Patent Application Publication
(10) Pub. No.: US 2026/0111550 A1
(43) Pub. Date: Apr. 23, 2026

(54) COMPUTER-READABLE RECORDING MEDIUM, RISK CALCULATION METHOD, AND RISK CALCULATOR

(71) Applicant: Fujitsu Limited, Kawasaki-shi (JP)

(72) Inventors: Maki INUI, Kawasaki (JP); Kentaro TSUJI, Kawasaki (JP); Jun YAJIMA, Kawasaki (JP)

(73) Assignee: Fujitsu Limited, Kawasaki-shi (JP)

(21) Appl. No.: 19/423,234

(22) Filed: Dec. 17, 2025

Related U.S. Application Data
(63) Continuation of application No. PCT/JP2023/022658, filed on Jun. 19, 2023.

(51) Int. Cl. G06F 21/57

(52) U.S. Cl. CPC G06F 21/57; G06F 2221/034

(57) ABSTRACT

A non-transitory computer-readable recording medium stores therein a risk calculation program that causes a computer to execute a process including, storing a weight for every attack condition, calculated with reference to a usage rate of each of the attack conditions, and a presence rate of each of a plurality of specification elements contained in a specification of the AI system, regarding the conditions for establishing the attack, the presence rate being defined in specifications of a plurality of existing AI systems, identifying an establishment status of the attack condition, with reference to information regarding the specification element extracted from information regarding the specification of an AI system subject to the risk determination, and calculating a risk score for every attack tree of the AI system subject to the risk determination, with reference to the weight for every attack condition, and the identified establishment status of the attack condition.

### FIELD

The present invention relates to a risk calculation program, a risk calculation method, and a risk calculator.

### BACKGROUND

A technique has been known to use artificial intelligence (AI) to estimate predetermined information and to recognize various objects, with reference to given data. In particular, AI implemented by machine training has attracted strong interest. AI system, thus expected to be used in a variety of fields, has been threatened by various attacks.

For example, there is a known attack called Adversarial Example. This attack adds a cleverly calculated noise to the original image to create an image which will be recognized by human as an object similar to the original image, but will be recognized by an AI system as some other object, thereby intentionally causing AI to make erroneous estimation. For example, addition of a noise to an image of a panda makes it possible to create an image that looks like a panda to human, but is judged to be a gibbon if classified with use of the AI system. A variety of other techniques has been known to attack the AI system.

As described above, the AI system in recent years has been increasingly threatened by attacks. There is therefore a need for enhancing attack resistance of the AI system. It is, however, not realistic to cope with all attacks because of enormous labor. It is, therefore, important to improve the resistance properly in accordance with the system requirements of the AI system. For this purpose, it is desirable at the time of development of the AI system to evaluate what kind of attack is applicable to the AI system by security analysis, and to examine a countermeasure by comparing the result with specification requirements and the like of the system.

One known measure against attacks on the AI system relates to a method of modifying the specification. Since attacks on the AI system are closely related to the specification, the method of modifying the specification is regarded as a security measure by which the specification of the AI system is modified so as to make attacks difficult.

There is a known technique for security analysis in common IT (Information Technology) security, called attack tree analysis. The attack tree analysis takes place following the procedures below. A tree is constituted while placing a possible damage to a system to be attacked at the highest top node, from which the tree branches downwards. The attack tree is created by setting the downward branching, while considering conditions for establishing the individual nodes to set branches or leaves for the individual nodes. Once the branches and the leaves are determined, meaning that any condition under which the attack tree is not established is identified, the specification of the system may be modified so as to inhibit the attack tree from being established. A system resistant to an attack that causes the assumed damage may be thus created.

A usual attack tree starts with a undefined structure, and will have set thereto information regarding the individual nodes or branches after the specification is determined. In contrast, the attacks and damages to the AI system will occur within limited types. For the attack tree analysis for the AI system, it is therefore possible to create an attack tree having registered therein the information regarding the individual nodes and branches, before the specification of the AI system is determined. Hence, the AI system can judge whether or not each attack is established, by preliminarily creating the attack tree, and by collating a condition registered for each node with the specification information in the AI system for checking.

Another technology of security analysis taking human damage into consideration has been proposed, analyzing that at what probability a threat from the viewpoint of a system provider could occur, by collecting vulnerability information of an Internet of Things (IoT) device from the web or the like, and by using the thus collected information. Yet another technology has been proposed to calculate an evaluation score of a new feature amount of an incident determination model, typically from similarity to a current feature amount, and an estimated contribution rate of incident determination, and to select a feature amount to be added.

Patent Literature 1: Japanese Laid-open Patent Publication No. 2019-145053

Patent Literature 2: Japanese Laid-open Patent Publication No. 2019-168796

Non Patent Literature 1: Jun Yajima, Takanori OIKAWA, Ikuya MORIKAWA, Fumiyoshi KASAHARA, Masaki INUI, Nobukazu YOSHIOKA, A Threat Analysis Method on Machine Learning Security for System Development Engineers, 2022 Symposium on Cryptography and Information Security (SCIS2022), Jan.18-21, 2022.

The technology of determining whether or not each attack is established based on collation of the conditions registered in the attack tree with the specification information will, however, be difficult to cope with a potential threat such as a new attack, since the technology is focused on attacks that already exist. Moreover, the AI system is often attacked by a combination of normal operations, in which a specific risk factor is extractable from the vulnerability information only with difficulty. Hence, even the technology for analyzing the probability at which the threat would occur with reference to the vulnerability information is difficult to cope with the potential threat. On the other hand, the technology for calculating the evaluation score of the new feature amount of the incident determination model, typically from the similarity of the current feature amount or from the estimated contribution rate of the incident determination, is focused on cyberattack, on the premise of availability of information according to which an event may be judged to be an attack or not. The technology is, therefore, not applicable to any attacks indistinguishable from the normal operation. It has therefore been difficult to enhance the security of the AI system, with use of any of the technologies.

A technology disclosed herein has been made in view of the aforementioned situation, wherein an object of which is to provide a risk calculation program, a risk calculation method, and a risk calculator that enhance the security of the AI system.

### SUMMARY

According to an aspect of an embodiment, a non- transitory computer-readable recording medium stores therein a risk calculation program that causes a computer to execute a process including, storing a weight for every attack condition, calculated with reference to a usage rate of each of the attack conditions that are elements for establishing a predetermined attack on an AI system, and a presence rate of each of a plurality of specification elements contained in a specification of the AI system, regarding the conditions for establishing the attack, the presence rate being defined in specifications of a plurality of existing AI systems, accepting information regarding the specification of an AI system subject to risk determination, identifying an establishment status of the attack condition, with reference to information regarding the specification element extracted from information regarding the specification of the AI system subject to the risk determination, for every attack tree created in advance, and calculating a risk score for every attack tree of the AI system subject to the risk determination, with reference to the weight for every attack condition, and the identified establishment status of the attack condition.

### BRIEF DESCRIPTION OF DRAWINGS

FIG. 1 is a block diagram of a risk calculator according to an embodiment.

FIG. 2 is a diagram illustrating an exemplary attack tree.

FIG. 3 is a diagram illustrating information regarding specifications of AI systems stored in an AI specification information database.

FIG. 4 is a diagram illustrating an exemplary raw score calculation with a logical expression given by AND and OR.

FIG. 5 is a diagram illustrating an attack tree whose logical expression contains NOT, and an exemplary raw score calculation using the same.

FIG. 6 is a diagram illustrating an attack tree that contains another attack scenario, and an exemplary raw score calculation using the same.

FIG. 7 is a diagram for explaining calculation of raw scores obtained after score calculation for every attack tree.

FIG. 8 is a diagram illustrating an exemplary calculation of weight for attack conditions.

FIG. 9 is a diagram illustrating an exemplary attack condition identification process.

FIG. 10 is a diagram illustrating an exemplary risk score calculation process.

FIG. 11 is a diagram illustrating an exemplary risk score notification.

FIG. 12 is a diagram outlining entire information provision with use of the risk calculation process according to the embodiment.

FIG. 13 is a flowchart regarding risk calculation and information provision processes with use of a risk calculator according to the embodiment.

FIG. 14 is a flowchart regarding an advance preparation process.

FIG. 15 is a flowchart regarding a risk determination process.

FIG. 16 is a hardware configuration diagram of the risk calculator.

### DESCRIPTION OF EMBODYMENT

Embodiments of the risk calculation program, the risk calculation method, and the risk calculator disclosed herein will be detailed, while referring to the attached drawings. Note that the risk calculation program, the risk calculation method, and the risk calculator disclosed herein are not limited by the embodiments below.

### Embodiments

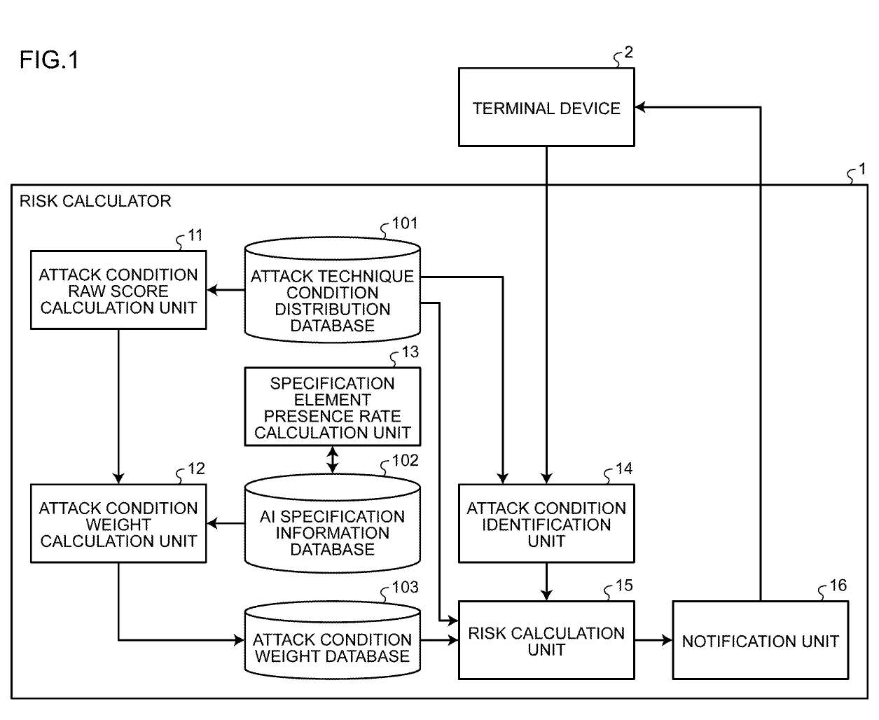

FIG. 1 is a block diagram of a risk calculator according to an embodiment. A risk calculator 1 is an apparatus that calculates a weight that represents risk of each operation given in an attack on the AI system, and calculates and then provides the risk of the attack on the AI system with use of the weight. The risk calculator 1 can therefore provide information that serves a basis for judging the level of security against any attack, either being known or unknown at present, given on the AI system subject to the risk determination.

Now, a possible measure against the attack on the AI system, aimed at calculating a future attack risk that has not been spread yet, is to use a specification of the AI system likely to be focused in the future by an attacker, rather than information such as vulnerability information obtainable as a result of the attack.

Now, tendencies of the attacker in the process of attack will be examined. One possibility is that the attacker will be very likely to aim at a specification of the AI system having been considered as a possible factor in a past attack, as a new target also for the future attack. This is because diversion of the attack method having already been spread will be convenient and very likely to be used. Another possibility is that the attacker will be very likely to customize the attack technique, in accordance with specifications of the AI system widely used at present. This is because at least the attacker will be less likely to use less popular conditions, as the conditions for making an attack. For example, there is almost no AI system that outputs internal data as response information. It is therefore considered that an attack which relies upon the specification of outputting the internal data as the response information is not practical.

Any operation in a specific attack on the AI system usually takes place within the normal operation of the AI system, so that it is difficult to directly determine a risk of the operation, and is also difficult to calculate therefrom a risk score of the attack, even if the attack condition holds. Now as will be described below, the risk calculator 1 calculates a risk score for a potential threat, while focusing whether or not the aforementioned two types of tendency of the attacker satisfy attack conditions having been used before for the attack.

The risk calculator 1 will be detailed below. As illustrated in FIG. 1, the risk calculator 1 has an attack condition raw score calculation unit 11, an attack condition weight calculation unit 12, a specification element presence rate calculation unit 13, an attack condition identification unit 14, a risk calculation unit 15, and a notification unit 16. The risk calculator 1 also has an attack technique condition distribution database 101, an AI specification information database 102, and an attack condition weight database 103. Processes handled by the risk calculator 1 include processes in an advance preparation phase for calculating a risk score for a specific AI system, and processes in a risk determination phase for actually calculating a risk score for the specific AI system with use of the information obtained in the advance preparation. Operations of the risk calculator 1 will be described below, while categorizing them into those for the advance preparation phase and the risk determination phase.

### Advance Preparation Phase

The attack technique condition distribution database 101 stores attack conditions, and expression information of an attack tree. The attack conditions represent the individual operations made by an attacker to establish the attack tree. The expression information of the attack tree, also being referred to as tree-structured information, is information that represents a structure of the attack tree, with use of attack information and logical expressions connecting them.

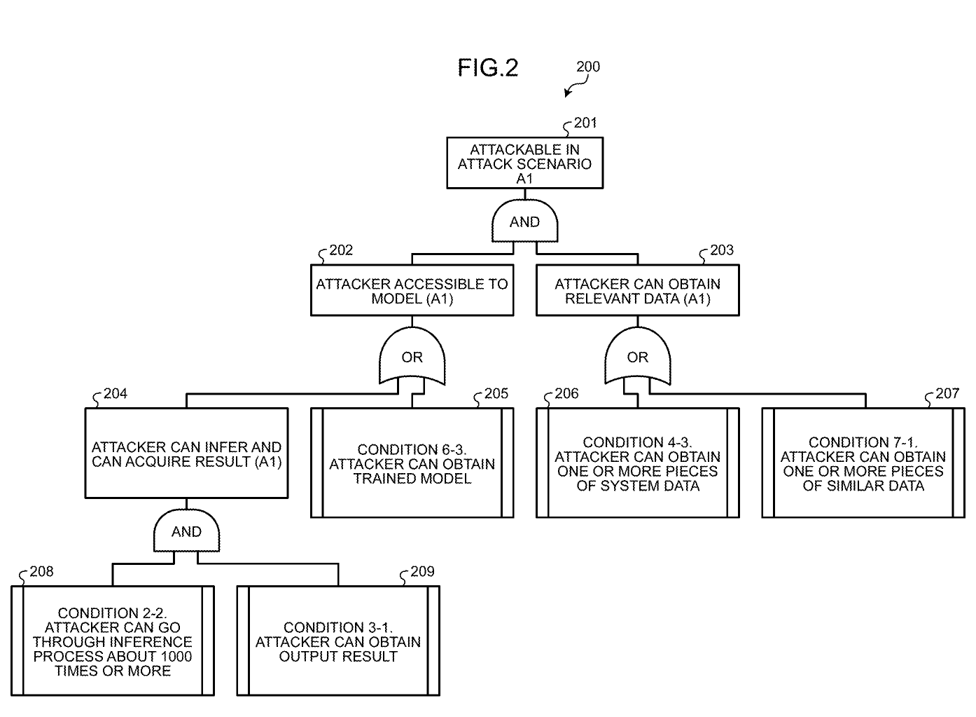

FIG. 2 is a diagram illustrating an exemplary attack tree. Each square frame in an attack tree 200 is called a node. The nodes are connected by logical expressions to form a hierarchy. Each of the nodes in the bottommost layer seen on the sheet is called "leaf". The leaf in the attack tree corresponds to attack condition or other attack scenario. The leaf in the attack tree corresponds to an example of a "second node".

If the attack tree 200 is established, an attack scenario A1 indicated at a node 201 in the topmost tier is established. The node 201 in the topmost tier is called root node. Also note that nodes other than the root node may occasionally be referred to as child nodes. The root node corresponds to an example of a "first node".

The attack tree 200 has five leaves named nodes 205 to 209. The nodes 205 to 209 correspond to attack conditions in the process of attack, and also correspond to specification conditions for constructing the AI system. Nodes 202 to 204 constitute a partial scenario for establishing an attack scenario A1. For example, if a condition 2-2 as an attack condition at the node 208 is satisfied, and a condition 3-1 at the node 209 is satisfied, a partial scenario at the node 204 is established. If the partial scenario at the node 204 is established, or a condition 6-3 as an attack condition at the node 205 is satisfied, a partial scenario at the node 202 is established. In addition, if a condition 4-3 as an attack condition at the node 206 is satisfied, or a condition 7-1 at the node 207 is satisfied, a partial scenario at the node 203 is established. If the partial scenario at the node 202 is established, and the partial scenario at the node 203 is established, the attack scenario A1 is established, thus establishing an attack on the AI system in the scenario A1.

As described above, types of attacks and damages on the AI system are limitative, thus allowing preliminary creation of the attack tree against the AI system. There is a plurality of attack trees that can be created in advance. Hence, the attack technique condition distribution database 101 can preliminarily acquire and store expression information for each of the plurality of attack trees. For example, expression information of the attack tree 200 illustrated in FIG. 2 is given by AND(OR(AND(2-2, 3-1), 6-3), OR(4-3, 7-1)).

For example, the user creates an attack tree for every attack technique against the AI system, and preliminarily registers and accumulates expression information for every attack tree, with use of a terminal device 2 into the attack technique condition distribution database 101. The user also collects specification elements of the AI system that can be attacked, with use of the attack tree thus created for every attack technique, and preliminarily registers and accumulates the specification elements thus collected as the attack conditions, with use of the terminal device 2 into the attack technique condition distribution database 101.

The AI specification information database 102 stores information regarding various specifications, including specifications corresponding to attack conditions collected from various existing AI systems, in association with each of the AI systems. The specification of the AI system for the attack condition means information that indicates whether or not the AI system corresponds to the specification element that corresponds to the attack condition. Correspondence of the AI system with the specification element means, in other words, that a content of the specification element is executed or satisfied by the AI system. The AI specification information database 102 also stores presence rates of the individual specification elements.

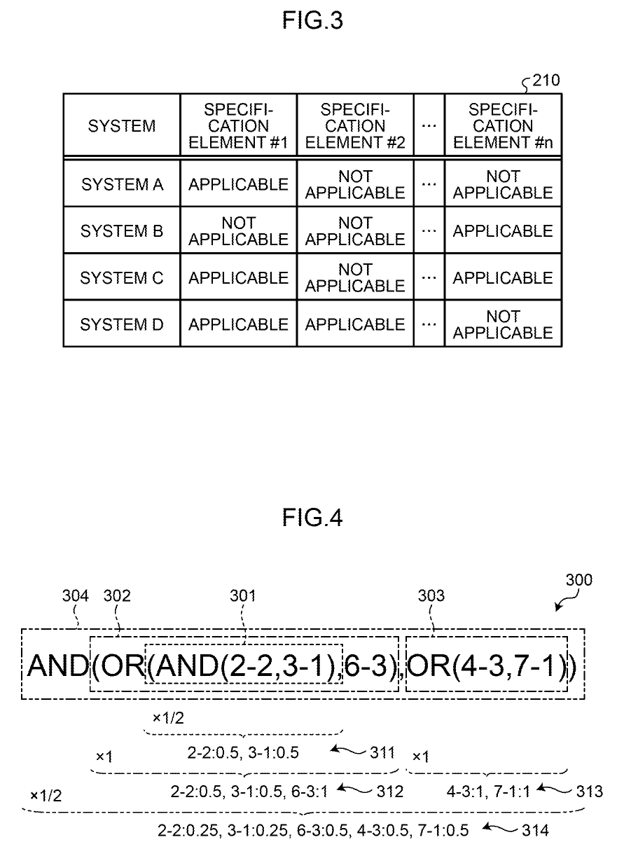

FIG. 3 is a diagram illustrating information regarding the specifications of the AI systems stored in the AI specification information database. For example, the AI specification information database 102 holds specification information for the individual AI systems, as presented by a table 210 in FIG. 3. FIG. 3 illustrates a case where information is held for four AI systems A to D. For example, the system A applies to specification element #1, but does not apply to specification elements #2 and #n.

For example, the user collects information regarding specifications of various existing AI systems, and registers and accumulates the collected information, typically with use of an input terminal (not illustrated) into the AI specification information database 102. Meanwhile, the presence rates of the specification elements are registered and accumulated by the specification element presence rate calculation unit 13, into the AI specification information database 102.

The attack condition weight database 103 stores information regarding weight for the individual attack conditions. The information regarding the weight of the attack conditions is registered and accumulated by the attack condition weight calculation unit 12, into the attack condition weight database 103. The attack condition weight database 103 corresponds to an example of the "storage unit".

The specification element presence rate calculation unit 13 acquires information regarding the specifications of various existing AI systems registered in the AI specification information database 102. The specification element presence rate calculation unit 13 then calculates the presence rate for each specification element, by dividing the number of applicable AI systems by the total number of AI systems from which the information regarding the specifications has been collected, for every specification element.

For example, in a case where the information regarding the specifications of the AI systems illustrated in FIG. 3 is held in the AI specification information database 102, the specification element presence rate calculation unit 13 calculates the presence rate of the specification element #1 as 3/4 = 0.75. The specification element presence rate calculation unit 13 also calculates the presence rate of the specification element #2 as 1/4 = 0.25. The specification element presence rate calculation unit 13 also calculates the presence rate of the specification element #n as 2/4 = 0.50.

The specification element presence rate calculation unit 13 then registers and accumulates the thus calculated presence rates of the individual specification elements, into the AI specification information database 102. The presence rate of the specification element indicates how abundantly the specification elements are present in the AI systems in the world, with respect to the attack condition corresponding to the specification conditions. More abundant specification element would be more likely to be used by the attacker. In other words, the presence rate of the specification element is understood to represent likeliness of being attacked by the attacker in the future. That is, the higher the presence rate of the specification element, the more likely the specification element is targeted by the attacker in the future.

The attack condition raw score calculation unit 11 acquires the attack conditions and the expression information of the attack tree, from the attack technique condition distribution database 101. The attack condition raw score calculation unit 11 then calculates the raw scores of the individual attack conditions according to a predetermined rule. Thereafter, the attack condition raw score calculation unit 11 outputs the thus calculated raw scores of the individual attack conditions, to the attack condition weight calculation unit 12. Exemplary calculation of raw scores of the attack conditions by the attack condition raw score calculation unit 11 will be explained below.

The attack condition raw score calculation unit 11 assigns one (1), for each leaf in the attack tree corresponding to the attack condition. The attack condition raw score calculation unit 11 then calculates the raw scores for the attack conditions corresponding to the individual leaves, while tracing the tree from the leaves towards the root on the basis of the expression information of the attack tree, in accordance with the rule below.

If the next logical expression in the tracing direction is given by AND, the attack condition raw score calculation unit 11 divides the score at that point by the number of conditions linked to the logical expression. That is, if the next logical expression is given by AND, Next score = (Score at that point) × (1/Number of conditions linked to logical expression) holds. On the other hand, if the next logical expression is given by OR, the attack condition raw score calculation unit 11 multiplies the score at that point by one (1). That is, if the next logical expression is given by OR, Next score = (Score at that point) × 1 holds.

For example, an explanation will be made while exemplifying an attack tree 200 in FIG. 2. FIG. 4 is a diagram illustrating an exemplary raw score calculation with a logical expression that contains AND and OR. An expression 300 presented in FIG. 4 represents the expression information of the attack tree 200. The attack condition raw score calculation unit 11 calculates raw scores of the attack conditions represented by the nodes 205 to 209, which are leaves of the attack tree 200. The attack conditions herein will be explained, while denoting them with reference numerals of the conditions in FIG. 2 corresponding to the attack conditions. For example, the attack condition corresponding to the node 208 will be denoted by condition 2-2.

First, the attack condition raw score calculation unit 11 assigns one (1), for each of the condition 2-2, condition 3-1, condition 6-3, condition 4-3, and condition 7-1. Next, the condition 2-2 fallen on the node 208 and the condition 3-1 fallen on the node 209 will lead to the next logical expression 301 given by AND, when viewed in the direction towards the node 201. Since there are two nodes that link to the logical expression 301, the attack condition raw score calculation unit 11 then multiplies the score of each of the conditions 2-2 and 3-1 by 1/2. In this case, as indicated by a score 311, the attack condition raw score calculation unit 11 calculates both the score of the condition 2-2 and the score of the condition 3-1, as 0.5. FIG. 4 herein presents scores 311 to 314 obtainable in the individual steps, in a format in which the reference numeral of the condition comes first, and the score follows. For example, 2-2:0.5 indicates that the condition 2-2 has a score of 0.5.

Next, the node 204 linked from the conditions 2-2 and 3-1, and the condition 6-3 at the node 205 will lead to the next logical expression 302 given by OR, when viewed in the direction towards the node 201. The attack condition raw score calculation unit 11 then multiplies the individual current scores of the condition 2-2, condition 7-1, and condition 6-3, by one (1). In this case, as indicated by a score 312, the attack condition raw score calculation unit 11 calculates both the score of the condition 2-2 and the score of the condition 3-1 as 0.5, meanwhile the score of the condition 6-1 as 1.

On the other hand, the condition 4-3 fallen on the node 206 and the condition 7-1 fallen on the node 207 will lead to the next logical expression 303 given by OR, when viewed in the direction towards the node 201. The attack condition raw score calculation unit 11 then multiplies the individual scores of the conditions 4-3 and 7-1, by one (1). In this case, as indicated by a score 313, the attack condition raw score calculation unit 11 calculates both the score of the condition 4-3 and the score of the condition 7-1, as 1.

Next, the node 202 linked from the condition 2-2, condition 3-1 and condition 6-3, and the node 203 linked from the condition 4-3 and condition 7-1 will lead to the next logical expression 304 given by AND, when viewed in the direction towards the node 201. Since there are two nodes that link to the logical expression 304, the attack condition raw score calculation unit 11 then multiplies the score of each of the condition 2-2, condition 3-1, condition 6-3, condition 4-3, and condition 7-1, by 1/2. In this case, as indicated by a score 314, the attack condition raw score calculation unit 11 calculates both the score of the condition 2-2 and the score of the condition 3-1 as 0.25, meanwhile the score of the condition 6-1, the score of the condition 4-3 and the score of the condition 7-1 as 0.5. In this way, the attack condition raw score calculation unit 11 can calculate the raw scores of the individual attack elements contained in the attack tree 200.

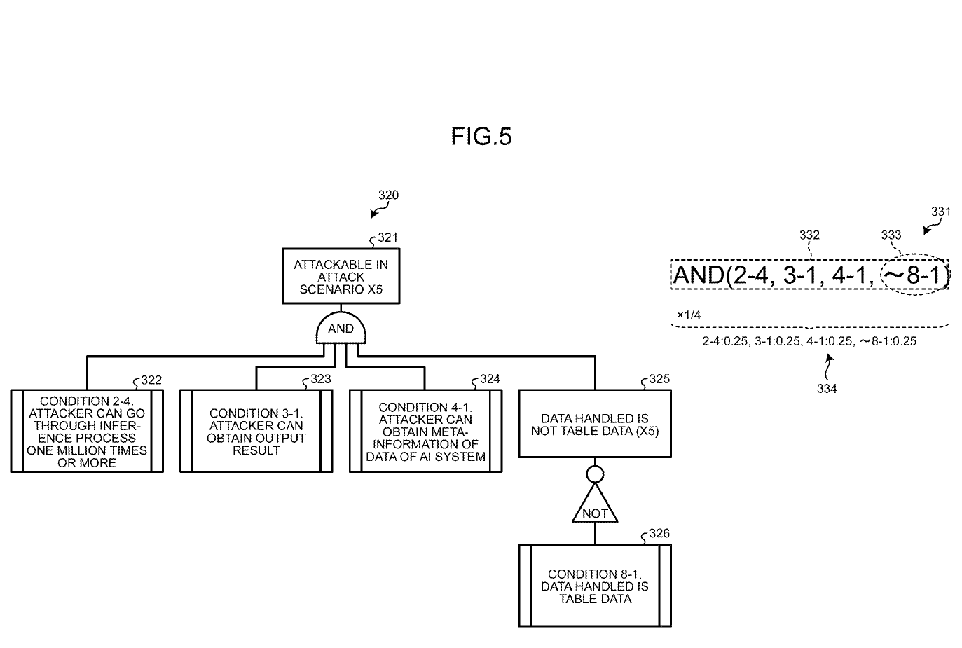

On the other hand, if the next logical expression is given by NOT, the attack condition raw score calculation unit 11 collectively handles all attack conditions up to the NOT, separately from the attack conditions linked to the logical expression from the lower tiers. FIG. 5 is a diagram illustrating an attack tree whose logical expression contains NOT, and an exemplary raw score calculation using the same. For example, the attack tree 320 illustrated in FIG. 5 has a node 326 linked to a logical expression given by NOT. An expression 331 represents expression information that represents the attack tree 320.

The attack condition raw score calculation unit 11 defines a condition 8-1 fallen in the node 326 inclusive of the NOT logical expression, collectively as a condition ~8-1, separately from the condition 8-1. The attack condition raw score calculation unit 11 then assigns one (1), for each of the condition 2-4, condition 3-1, condition 4-1, and condition ~8-1. A logical expression next to nodes 322 to 325, in the direction towards the root node, or a node 321, is given by AND, which is represented by a logical expression 332 in the expression 331. Now, the node 325 following the node 326 via NOT is denoted by ~8-1 as indicated by an element 333 in an expression 331. Since there are four nodes that link to this logical expression, the attack condition raw score calculation unit 11 then multiplies the score of each of the condition 2-4, condition 3-1, condition 4-1, and condition ~8-1, by 1/4. In this case, as indicated by a score 334, the attack condition raw score calculation unit 11 calculates the score of the condition 2-4, the score of the condition 3-1, the score of the condition 4-1, and the score of the condition ~8-1, all as 0.25. In this way, the attack condition raw score calculation unit 11 can calculate the raw scores of the individual attack elements contained in the attack tree 320.

In a case where a node in an attack tree under examination conditionally involves establishment of another attack scenario, the attack condition raw score calculation unit 11 brings all attack conditions contained in the attack tree that establishes the attack scenario, as attack conditions into the attack tree under examination. In this case, the attack condition raw score calculation unit 11 calculates the scores, by taking over the scores of the individual attack conditions calculated in the attack tree of the another attack scenario.

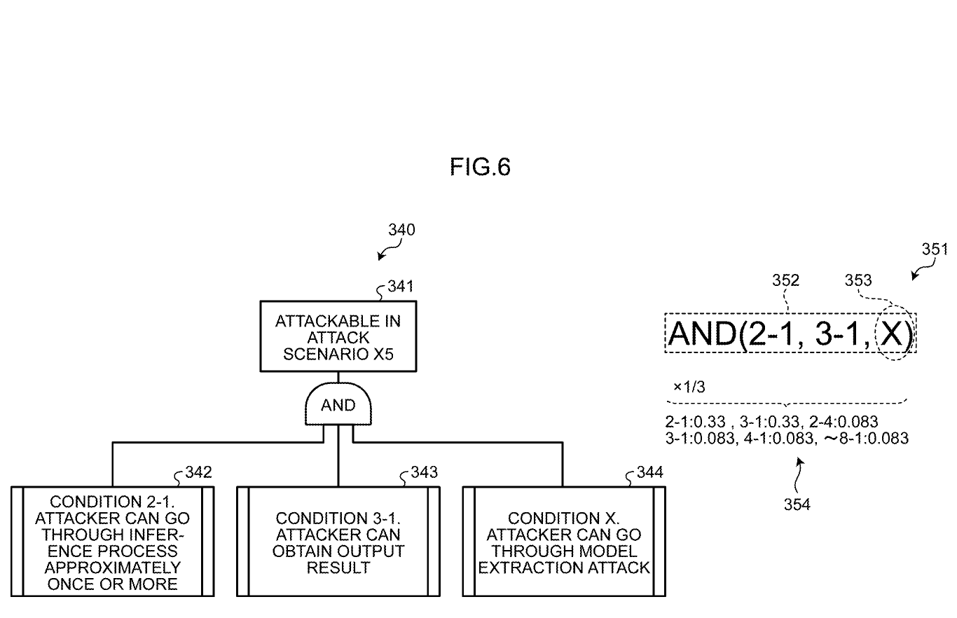

FIG. 6 is a diagram illustrating an attack tree that contains another attack scenario, and an exemplary raw

score calculation using the same. For example, the attack condition indicated by the node 344 contained in the attack tree 340 illustrated in FIG. 6 corresponds to the another attack scenario, which is established upon establishment of the attack tree 320 in FIG. 5. An expression 351 represents expression information that represents the attack tree 340. A condition 353 in the expression 351 corresponds to an attack condition corresponding to the another attack scenario indicated by the node 344.

All of the condition 2-4, condition 3-1, condition 4-1, and condition ~8-1, which are attack conditions in the attack tree 320 in FIG. 5, have a score of 0.25. The attack condition raw score calculation unit 11 then assumes that the condition 2-4, condition 3-1, condition 4-1, and conditions ~8-1, all having a score of 0.25, are linked below the node 344. The attack condition raw score calculation unit 11 also assigns a score of one (1), for the condition 2-1 fallen on the node 342, and the condition 3-1 fallen on the node 343. Then, a logical expression next to nodes 342 to 344, in the direction towards the root node, or a node 341, is given by AND, which is represented by a logical expression 352 in the expression 351. Since there are three nodes that link to this logical expression, the attack condition raw score calculation unit 11 then multiplies the current score of each of the condition 2-1, condition 3-1, condition 2-4, condition 3-1, condition 4-1, and condition ~8-1, by 1/3. In this case, as indicated by a score 354, the attack condition raw score calculation unit 11 calculates both the scores of the condition 2-1 and condition 3-1 as 0.33, meanwhile all the scores of the condition 2-4, condition 3-1, condition 4-1 and condition ~8-1 as 0.073.

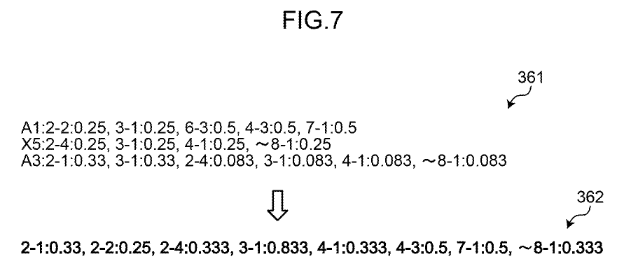

Next, the attack condition weight calculation unit 12 calculates a sum of the scores for the individual attack conditions for every attack tree, and calculates the raw score for each of the attack conditions. FIG. 7 is a diagram for explaining calculation of the raw scores obtained after the score calculation for every attack tree. A score calculation result 361 in FIG. 7 indicates the scores of the individual attack conditions in the attack trees for attack scenarios A1, X5 and A3.

For example, the attack condition raw score calculation unit 11 calculates the scores of the individual attack conditions in the attack trees for each of the attack scenarios A1, X5 and A3, as indicated by the score calculation result 361. The attack condition raw score calculation unit 11 then calculates the raw scores of the individual attack conditions, by adding up the scores of the same attack conditions in each of the attack trees. As indicated by a raw score calculation result 362, the attack condition raw score calculation unit 11 calculates the raw scores of the conditions 2-1, 2-2, 2-4, 3-1, 4-1, 4-3, 7-1 and ~8-1, which are attack conditions contained in at least any one of the individual attack trees. For example, since the condition 3-1 is present in all the attack trees of the attack scenarios A1, X5 and A3, the attack condition raw score calculation unit 11 then calculates the raw score for the condition 3-1, by adding three scores in a way given by 0.25 + 0.25 + 0.33 = 0.833. In another example, since the condition 2-1 is present in the attack tree of the attack scenario A3, but is absent in the attack scenarios A1 and X5, the attack condition raw score calculation unit 11 then directly employs 0.33, which is a score in the attack tree of the attack scenario A3, as the raw score for the condition 2-1.

Now, the raw score of the attack condition corresponds to a usage rate of the attack condition in the attack, in other words, represents likeliness of being used as the attack condition. That is, in a case where the attack conditions are linked by AND, a condition based on an attack condition is not established unless all the attack conditions are satisfied, thus making the attack condition less likely to be used accordingly. On the other hand, in a case where the attack conditions are linked by OR, a condition based on an attack condition is established if only any of the attack conditions is satisfied, thus leaving the likeliness of usage of the attack condition unchanged. It is therefore preferred in the raw score calculation to employ a rule under which the attack condition linked by AND will have low scores, meanwhile the attack condition linked by OR will have scores left unchanged. That is, in a case where a predetermined attack condition in the tree-structured information is alternatively selected among the other attack conditions (that is, in a case where the attack conditions are linked by OR in the logical expression), the attack condition raw score calculation unit 11 calculates the usage rate so as to lower the usage rate of the predetermined attack condition.

The attack condition weight calculation unit 12 receives input of the raw scores of the individual attack conditions, from the attack condition raw score calculation unit 11. The attack condition weight calculation unit 12 also acquires the presence rates of the specification elements of the AI systems from the AI specification information database 102.

Next, the attack condition weight calculation unit 12 calculates the weight of the individual attack conditions, by multiplying the raw scores of the individual attack conditions by the presence rates of the AI specification elements. That is, the attack condition weight calculation unit 12 calculates the weight so that the attack condition with higher usage rate in the attack will have larger weight, and so that the attack condition that corresponds to the specification element with higher presence rate in the existing AI system will have larger weight. Thereafter, the attack condition weight calculation unit 12 stores and accumulates the individual attack conditions in association with the weight calculated for every attack condition, in the attack condition weight database 103.

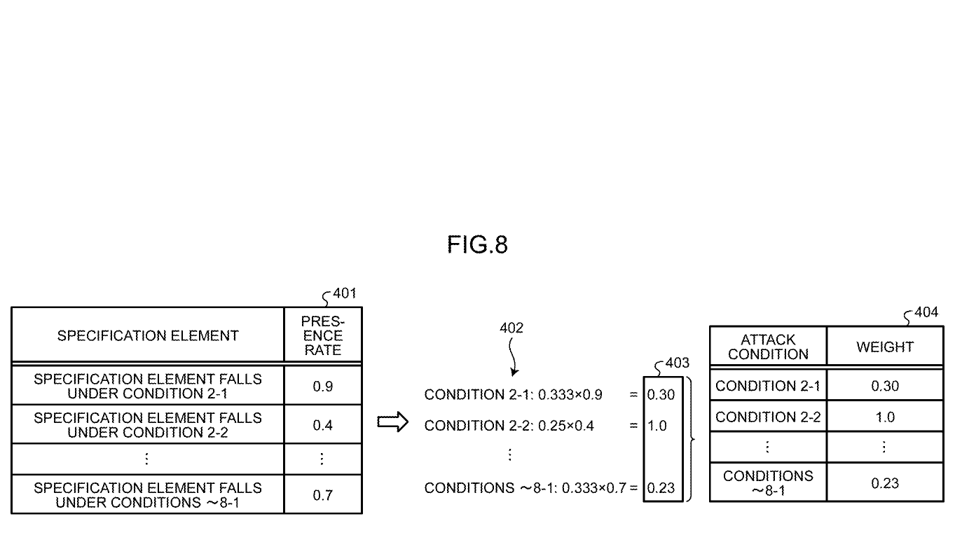

FIG. 8 is a diagram illustrating an exemplary weight calculation for the attack conditions. For example, the attack condition weight calculation unit 12 acquires, as the presence rate of the specification element of the AI system, information contained in a table 401 from the AI specification information database 102. The attack condition weight calculation unit 12 then multiplies the raw score of each attack condition by the presence rate of the specification element, for every attack condition as illustrated by a calculation 402, to calculate a weight 403. The attack condition weight calculation unit 12 then stores and accumulates the individual attack conditions in association with the weights thereof, in the attack condition weight database 103, as illustrated in a table 404, for example.

### Risk Determination Phase

The attack condition identification unit 14 receives input of the specification of a specific AI system subject to risk determination, through the terminal device 2. The attack condition identification unit 14 also acquires information regarding the attack trees and the attack conditions for the individual attack scenarios, from the attack technique condition distribution database 101. The attack condition identification unit 14 then assigns True to the attack condition that corresponds to the specification element to which the specific AI system applies, among the individual specification elements. Meanwhile, the attack condition identification unit 14 assigns False to the attack condition that corresponds to the specification element to which the specific AI system does not apply, among the individual specification elements.

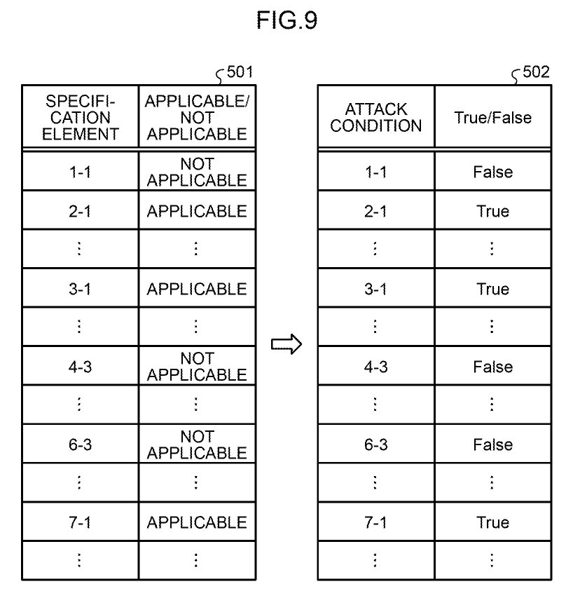

FIG. 9 is a diagram illustrating an exemplary attack condition identification process. For example, the attack condition identification unit 14 acquires the specification of a specific AI system subject to risk determination listed in a table 501. The attack condition identification unit 14 then assigns True to the attack conditions that correspond to the specification elements to which the specific AI system applies, meanwhile assigns False to the attack conditions that correspond to the specification elements not applicable, as illustrated in a table 502.

In this way, the attack condition identification unit 14 can identify the attack conditions found to be True, as the attack conditions that can be established in the specific AI system. Thereafter, the attack condition identification unit 14 outputs the establishment status of the attack conditions in the specific AI system subject to the risk determination, to the risk calculation unit 15. For example, the attack condition identification unit 14 may output the table 502 illustrated in FIG. 9, to the risk calculation unit 15.

The risk calculation unit 15 receives input of the information regarding the establishment status of the attack conditions in the specific AI system subject to risk determination, from the attack condition identification unit 14. The risk calculation unit 15 also acquires the weight of the individual attack conditions, from the attack condition weight database 103. The risk calculation unit 15 also acquires structure information of the attack trees for the individual attack scenarios, from the attack technique condition distribution database 101.

The risk calculation unit 15 then adds up the weights of the attack conditions found to be True for every attack tree, to calculate a risk score of the specific AI system for every attack tree. Thereafter, the risk calculation unit 15 outputs the risk score of the specific AI system, calculated for every attack tree, to the notification unit 16.

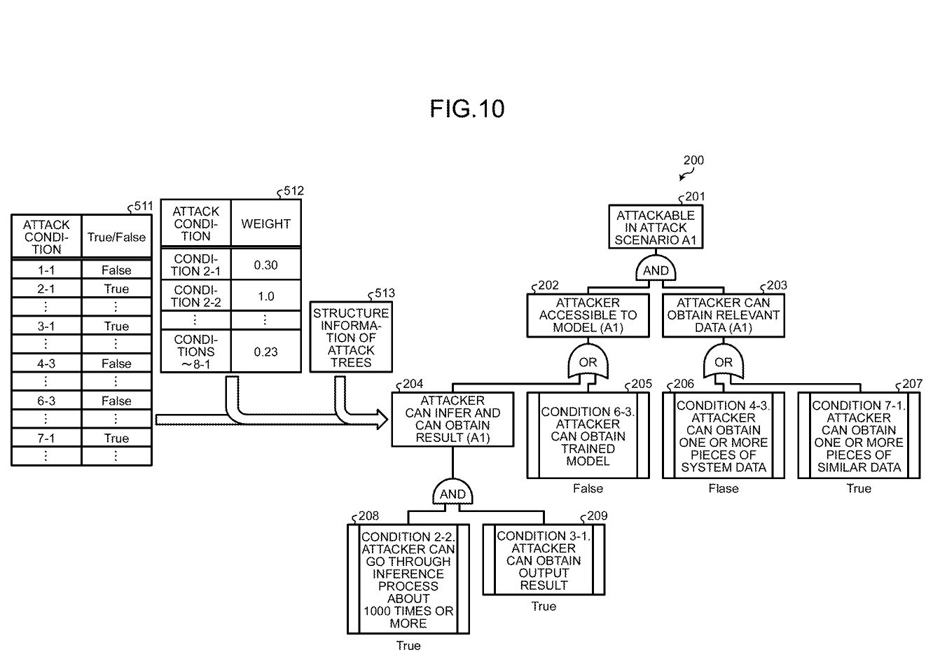

FIG. 10 is a diagram illustrating an exemplary risk score calculation process. For example, the risk calculation unit 15 acquires the establishment status of the attack conditions presented by a table 511, the weight of the individual attack conditions presented by a table 512, and the structure information of the attack trees 513.

Next, the risk calculation unit 15 acquires the weight of the individual attack conditions found to be True in the table 511, from the table 512. Next, the risk calculation unit 15, for example, identifies the attack conditions corresponding to the nodes 205 to 209 in the attack tree 200, from the structure information of attack trees 513. Since, the attack conditions herein, corresponding to the nodes 207 to 209, are found to be True, the risk calculation unit 15 then adds up the individual weights, to calculate the risk score for the specific AI system in the attack scenario A1 represented by the attack tree 200.

Note now that the risk calculation unit 15 in this embodiment was structured to acquire the structure information of the attack tree contained in the own device from the attack technique condition distribution database 101, and to acquire the establishment status of the attack conditions from the attack condition identification unit 14. The risk calculation unit 15 is, however, not limited thereto, instead allowing acquisition of these pieces of information from some other function by which whether or not the individual attacks can be established is determined, by collating the conditions and the specification information registered to the attack tree.

The risk calculation unit 15 can also determine whether or not the attack scenarios represented by the individual attack trees are established, from the establishment status of the individual attack conditions in the specific AI system. Hence, the risk calculation unit 15 can also output information regarding possibility of the attacks in the individual attack scenarios, to the notification unit 16.

The notification unit 16 receives input of the risk score of the specific AI system subject to the risk determination, calculated for every attack tree, from the risk calculation unit 15. The notification unit 16 then transmits information regarding the risk scores of the specific AI system, calculated for every attack tree, to the terminal device 2, thereby notifying the user of security risk on the specific AI system.

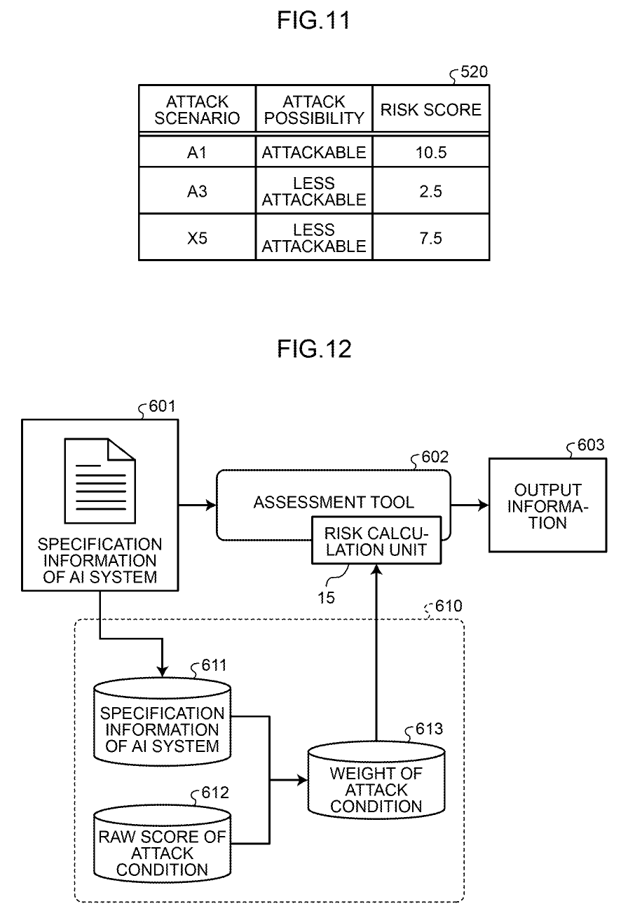

FIG. 11 is a diagram illustrating exemplary notification of the risk score. For example, the notification unit 16 acquires information regarding possibility of the attacks in the individual attack scenarios, together with the risk scores of the attack trees corresponding to the individual attack scenarios, from the risk calculation unit 15. Next, the notification unit 16 creates a table 520 that summarizes possibility of attack and the risk score for every attack scenario. The notification unit 16 can transmit the created table 520 to the terminal device 2 and allows the table to be displayed on the screen, thereby notifying the user of the security risk on the specific AI system.

FIG. 12 is a diagram outlining entire information provision with use of a risk calculation process according to the embodiment. Exemplary information provision with use of the risk calculation process according to the embodiment will now be outlined, while referring to FIG. 12. An advance preparation process 610 in FIG. 12 is a process implemented by the attack condition raw score calculation unit 11, the attack condition weight calculation unit 12, and the specification element presence rate calculation unit 13 illustrated in FIG. 1.

The advance preparation process 610 acquires AI system specification information 611 regarding an existing AI system, from among AI system specification information 601. Further, the advance preparation process 610 calculates the raw score 612 of the attack condition. The advance preparation process 610 then calculates weight 613 of the attack condition, with use of the AI system specification information 611 and the raw score 612 of the attack condition.

The risk calculation unit 15 can operate as a part of an assessment tool 602 that evaluates the AI system. The assessment tool 602 acquires specification information of a specific AI system subject to risk determination, from among the AI system specification information 601. The risk calculation unit 15 then calculates a risk score for every attack tree in the specific AI system, with use of the specification information of the specific AI system and the weight 613 of the attack condition acquired by the assessment tool 602. The assessment tool 602 incorporates the information regarding the risk score calculated for every attack tree by the risk calculation unit 15, into evaluation of the specific AI system, and provides them as output information 603 to the user.

### Risk Calculation and Information Provision Process

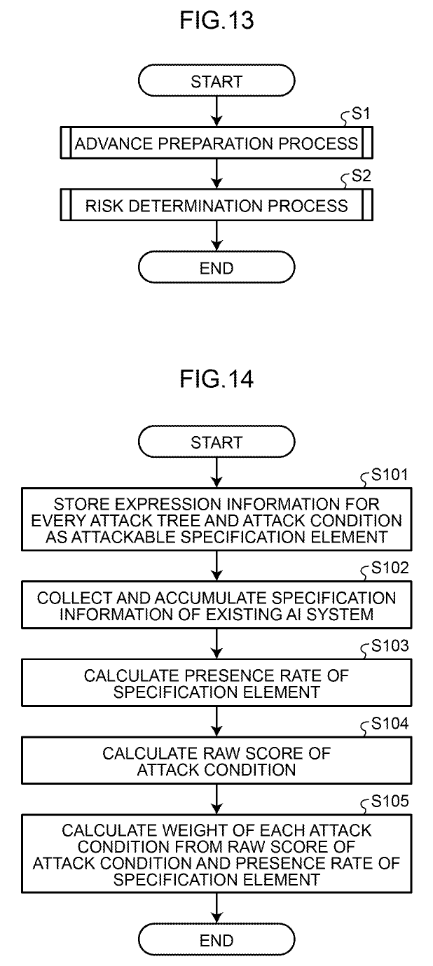

FIG. 13 is a flowchart regarding risk calculation and information provision processes with use of the risk calculator according to the embodiment. Next, a flow of the risk calculation and information provision processes with use of the risk calculator 1 according to the embodiment will be explained, while referring to FIG. 13.

Prior to the risk calculation for the AI system, the attack condition raw score calculation unit 11, the attack condition weight calculation unit 12, and the specification element presence rate calculation unit 13 execute an advance preparation process for acquiring the weight of the individual attack conditions used for calculating the risk (step S1).

The attack condition identification unit 14 and the risk calculation unit 15 execute a risk identification process by which an input risk of the AI system is calculated and notified, with use of the weight of the individual attack conditions obtained in the advance preparation process (step S2).

FIG. 14 is a flowchart regarding the advance preparation process. The individual processes in the flow illustrated in FIG. 14 correspond to an example of a process executed in step S1 in FIG. 13. Next, a flow of the advance preparation process will be explained while referring to FIG. 14.

The attack technique condition distribution database 101 receives and stores expression information for every attack tree, and attack conditions as attackable specification elements (step S101).

The AI specification information database 102 collects and accumulates information regarding the specifications of a plurality of existing AI systems (step S102).

The specification element presence rate calculation unit 13 acquires the specification information of the existing AI systems accumulated in the AI specification information database 102. The specification element presence rate calculation unit 13 then calculates the presence rates for the individual specification elements, by dividing the number of applicable AI systems by the total number of AI systems from which the specification information has been collected, for every specification element (step S103). Thereafter, the specification element presence rate calculation unit 13 registers the thus calculated presence rates of the individual specification elements, into the AI specification information database 102.

The attack condition raw score calculation unit 11 calculates the scores of the individual attack conditions, with use of the attack conditions and the expression information of the attack tree stored in the attack technique condition distribution database 101. The attack condition raw score calculation unit 11 then calculates the raw scores of the individual attack conditions, by adding up the scores of the individual attack conditions for every attack tree (step S104).

The attack condition weight calculation unit 12 acquires the raw scores of the individual attack conditions calculated by the attack condition raw score calculation unit 11. The attack condition weight calculation unit 12 also acquires the presence rates of the individual specification elements, from the AI specification information database 102. The attack condition weight calculation unit 12 then multiplies the raw score of each attack condition, by the presence rate of the specification element corresponding to the attack element, for every attack element (step S105). Thereafter, the attack condition weight calculation unit 12 stores and accumulates the thus calculated weight of the individual attack conditions, into the attack condition weight database 103.

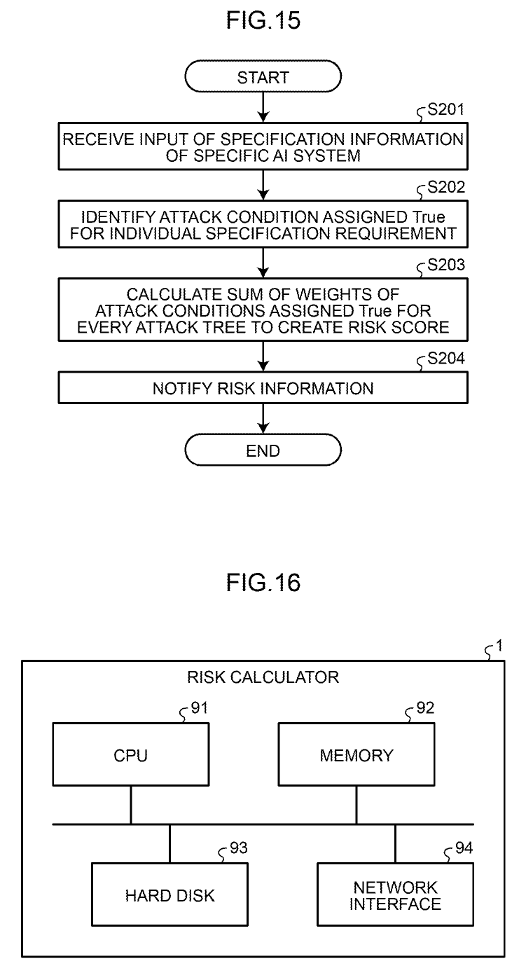

FIG. 15 is a flowchart regarding the risk determination process. The individual processes in the flow illustrated in FIG. 15 correspond to an example of a process executed in step S2 in FIG. 13. Next, a flow of the risk determination process will be explained while referring to FIG. 15.

The attack condition identification unit 14 receives input of the specification information of the specific AI system subject to risk determination, through the terminal device 2 (step S201).

The attack condition identification unit 14 then identifies the attack conditions assigned True for the individual specification requirements, from the thus acquired information regarding the specification (step S202).

The risk calculation unit 15 acquires information regarding the establishment status of the attack conditions including the information regarding the attack conditions assigned True, from the attack condition identification unit 14. The risk calculation unit 15 also acquires the weight of the individual attack conditions, from the attack condition weight database 103. The risk calculation unit 15 also acquires structure information of the attack trees, from the attack technique condition distribution database 101. The risk calculation unit 15 then calculates the sum of the weights of the attack conditions found to be True for every attack tree, and defines the thus calculated values as the risk scores for the individual attack trees of the specific AI system (step S203).

The notification unit 16 transmits the risk information regarding the specific AI system, including the risk score calculated by the risk calculation unit 15, to the terminal device 2, thereby notifying the user of the risk information (step S204).

As described above, the risk calculator according to this embodiment goes through the processes below, as the advance preparation for the risk calculation. The risk calculator calculates the usage rate of the specification element with reference to the collected information on the specification of the existing AI system, and determines probability of being attacked in the future for the individual specification elements. The risk calculator also calculates the scores of the individual attack conditions with reference to the structure of the attack tree, and calculates to what degree the individual attack conditions are likely to be used for the attack. The risk calculator then calculates the weight of the individual attack conditions, with use of the usage rates of the specification elements and the raw scores of the attack conditions. After completion of the advance preparation, the risk calculator acquires the information regarding the specification of the AI system subject to the risk calculation, and calculates the risk score of the AI system subject to the risk calculation, for every attack tree with use of the weight of the attack condition assigned True.

As described above, the risk calculator according to this embodiment can calculate the risk score, including a potential risk for the AI system based on the specification information of the AI system and the possibility of being the target of an attack under the attack conditions. That is, the risk calculator according to this embodiment can calculate the level of security of the AI system including any potential threat, while taking not only simply whether the attack is established or not, but also tendencies of the attack into consideration. The potential threat includes a threat in an unknown attack scenario or the like. This makes it possible to visualize and present, to the user, the potential threat of any attack that has been determined to be hardly established, or has been out of the scope of examination of feasibility and has been difficult to analyze. Furthermore, with the information regarding the risk of a future attack presented, the developer of the AI system will become able to take measures such as preliminarily eliminating elements suspected of causing the attack. Hence, the security of the AI system may be enhanced.

### Hardware Configuration

FIG. 16 is a hardware configuration diagram of the risk calculator. Next, an exemplary hardware configuration for implementing the individual functions of the risk calculator 1 will be explained, while referring to FIG. 16.

As illustrated in FIG. 16, the risk calculator 1 has, for example, a central processing unit (CPU) 91, a memory 92, a hard disk 93, and a network interface 94. The CPU 91 is connected through a bus to the memory 92, the hard disk 93, and the network interface 94.

The network interface 94 is an interface for communication between the risk calculator 1 and an external device. The network interface 94 relays, for example, communication between the terminal device 2 and the CPU 91.

The hard disk 93 is an auxiliary storage device. The hard disk 93 can implement the functions of the attack technique condition distribution database 101, the AI specification information database 102, and the attack condition weight database 103 exemplified in FIG. 1. The hard disk 93 stores various programs including a program for implementing the functions of the attack condition raw score calculation unit 11, the attack condition weight calculation unit 12, the specification element presence rate calculation unit 13, the attack condition identification unit 14, the risk calculation unit 15, and the notification unit 16 exemplified in FIG. 1.

The memory 92 serves as a main storage device. A dynamic random access memory (DRAM), for example, may be used as the memory 92.

The CPU 91 reads various programs from the hard disk 93, and develops them on the memory 92 for execution. In this way, the CPU 91 implements the functions of the attack condition raw score calculation unit 11, the attack condition weight calculation unit 12, the specification element presence rate calculation unit 13, the attack condition identification unit 14, the risk calculation unit 15, and the notification unit 16 exemplified in FIG. 1.

One aspect of the risk calculation program, the risk calculation method, and the risk calculator disclosed herein can effectively enhance the security of the AI system.

1. A non-transitory computer-readable recording medium having stored therein a risk calculation program that causes a computer to execute a process comprising:
storing a weight for every attack condition, calculated with reference to a usage rate of each of the attack conditions that are elements for establishing a predetermined attack on an AI system, and a presence rate of each of a plurality of specification elements contained in a specification of the AI system, regarding the conditions for establishing the attack, the presence rate being defined in specifications of a plurality of existing AI systems;
accepting information regarding the specification of an AI system subject to risk determination;
identifying an establishment status of the attack condition, with reference to information regarding the specification element extracted from information regarding the specification of the AI system subject to the risk determination, for every attack tree created in advance; and
calculating a risk score for every attack tree of the AI system subject to the risk determination, with reference to the weight for every attack condition, and the identified establishment status of the attack condition.

2. The non-transitory computer-readable recording medium according to claim 1, wherein the process further includes
acquiring pieces of tree-structured information that represent structures of a plurality of attack trees containing a first node associated to information that represents the predetermined attack, and a plurality of second nodes individually associated to the attack conditions;
calculating the usage rate for each of the attack conditions, with reference to the tree-structured information;
acquiring information regarding specifications of the plurality of existing AI systems;
calculating a presence rate for each of the specification elements, with reference to information regarding specifications of the plurality of existing AI systems; and
calculating and then storing a weight for every attack condition, with reference to a usage rate of each of the attack conditions, and a presence rate of each of the specification elements.

3. The non-transitory computer-readable recording medium according to claim 2, wherein the process further includes, in a case where a predetermined attack condition in the tree-structured information is alternatively selected among the other attack conditions, calculating a usage rate of each of the attack conditions so as to lower the usage rate of the predetermined attack condition.

4. The non-transitory computer-readable recording medium according to claim 1, wherein the process further includes calculating a presence rate of each of the specification elements, with reference to the number of existing AI systems whose specification information contains the specification element, and a total number of existing AI systems for which the specification information has been acquired.

5. A risk calculating method comprising:
storing a weight for every attack condition calculated with reference to a usage rate of each of the attack conditions that are elements for establishing a predetermined attack on an AI system, and a presence rate of each of a plurality of specification elements contained in a specification of the AI system, regarding the conditions for establishing the attack, the presence rate being defined in specification of a plurality of existing AI systems;
accepting information regarding the specification of an AI system subject to risk determination;
identifying an establishment status of the attack condition, with reference to information regarding the specification element extracted from information regarding the specification of the AI system subject to the risk determination, for every attack tree created in advance; and
calculating a risk score for every attack tree of the AI system subject to the risk determination, with reference to the weight for every attack condition, and the identified establishment status of the attack condition by a processor.

6. A risk calculator, comprising:
a memory; and
a processor coupled to the memory and configured to:
store a weight for every attack condition, calculated with reference to a usage rate of each of the attack conditions that are elements for establishing a predetermined attack on an AI system, and a presence rate of each of a plurality of specification elements contained in a specification of the AI system, regarding the conditions for establishing the attack, the presence rate being defined in specification of a plurality of existing AI systems, in the memory;
accept information regarding the specification of an AI system subject to risk determination, and identifies an establishment status of the attack condition, with reference to information regarding the specification element extracted from information regarding the specification of the AI system subject to the risk determination, for every attack tree created in advance; and
calculate a risk score for every attack tree of the AI system subject to the risk determination, with reference to the weight for every attack condition stored in the memory, and the establishment status of the attack condition identified.
